(19) United States
(12) Patent Application Publication
(10) Pub. No.: US 2014/0326000 A1
(43) Pub. Date: Nov. 6, 2014

(54) LNG Tank Vapor Management Using a CNG Accumulator

(71) Applicant: CATERPILLAR INC., Peoria, IL (US)

(72) Inventor: Stephen Sampson, Bloomington, IL (US)

(73) Assignee: Caterpillar Inc., Peoria, IL (US)

(21) Appl. No.: 13/875,144

(22) Filed: May 1, 2013

(51) Int. Cl. F17C 13/02; F17C 7/04

(52) U.S. Cl. CPC F17C 13/025; F17C 7/04
USPC 62/49.1; 62/50.2

(57) ABSTRACT

A liquid natural gas tank (LNG) pressure management system is provided. The system includes an LNG bulk tank, an LNG fuel tank operably connected to the LNG bulk tank, a compressed natural gas (CNG) accumulator operably connected to the LNG fuel tank and a liquid natural gas cryogenic pump operably connected to the liquid natural gas fuel tank and the liquid natural gas bulk tank. The pressure management system is configured to direct boil off gas (BOG) to the compressed natural gas accumulator upon a predetermined condition.

### TECHNICAL FIELD

The present disclosure relates generally to liquid natural gas fuel tanks and more particularly to a system and method for nun aging boil-off gas in a liquid natural gas fuel tank using a compressed natural gas accumulator.

### BACKGROUND

Natural gas is one of the cleanest burning fuels presently known. Moreover, the current cost of natural gas makes it a cost effective alternative to other fuels due to its easy access and long term availability. Natural gas is commonly stored and/or delivered in two different forms, compressed natural gas (CNG) and liquefied natural gas (LNG).

The use of CNG as a fuel for motor vehicles has been known for many years and has become increasingly popular in many areas of the world especially as gasoline prices rise. One obstacle to the use of the compressed natural gas vehicles is that compressed natural gas vehicles require a greater amount of space for fuel storage than conventional gasoline powered vehicles. Since it is a compressed gas, rather than a liquid like gasoline, CNG takes up more space for each unit of gasoline equivalence. Therefore, the tanks used to store the CNG usually take up greater space in a vehicle, which runs on CNG compared to a conventional gasoline tank.

Natural gas, however, can be liquefied as LNG and stored in a specially designed insulated cryogenic tank, The LNG can then he heated to CNG on hoard the vehicle and the CNG can be used to fuel the engine. The primary advantage of LNG compared to CNG is that it can be stored at a relatively low pressure (20 to 150 psi) at about one-third the volume and one-third the weight of an equivalent CNG storage tank system. The major disadvantage is the need to deal with the storage and handling of a cryogenic (−160° C., −260° F.) fluid through the entire process of bulk transport and transfer to fleet storage.

For example, one challenge associated with a natural gas or a diesel/natural gas dual fuel powered systems is the amount of time required to fill the LNG fuel tank and empty the LNG fuel tank at the LNG fuel station. Boil off of LNG causes excessive pressure buildup in LNG fuel tanks. Gaseous natural gas or boil off gas (BOG) accumulates at the top of the LNG fuel tank during fuel transfer, which increases filling time and reduces the volume in the LNG fuel tank available to hold LNG used as fuel for the system. A similar problem occurs when the LNG fuel tank is emptied for service reasons.

Boil off of LNG is caused by heat addition to the LNG fuel during storage and fueling. Heat can transfer through the shell of the fuel tank and into the LNG fuel during operation. For example, heat may be transferred through the hose and dispensers used to fuel an LNG fuel tank to the LNG fuel and generate BOG in the LNG fuel tank.

The amount of time it takes to refuel can have significant economic consequences for a natural gas powered system because the system is not in service when it is being refueled and cannot return to service until refueling is complete. Therefore, it would he advantageous to reduce the amount of time required for refueling and discharging the LNG fuel tank such that the natural gas powered engine could return to service more quickly and any downtime for the system is minimized.

Different approaches have been taken to address this problem of BOG accumulating in the LNG fuel tank during LNG tilling and emptying procedures. One approach has been to vent the BOG from the LNG fuel tank into the atmosphere, but environmental concerns related to potentially negative effects of releasing methane gas into the atmosphere do not make this approach desirable. Furthermore, a considerable amount of natural gas could be wasted if the BOG is simply vented to the atmosphere.

Another approach has been to vent the BOG from the LNG fuel tank to the bulk LNG supply tank that is used to supply LNG to the fuel tank. While this approach, immediately relieves pressure in the fuel tank caused by BOG, it introduces heat from the BOG into the LNG supply tank, which potentially could create an undesirably high pressure in the LNG supply tank. This heat would then ultimately be re-introduced to the LNG fuel tank. Other approaches include transferring the BOG to a pipeline system, using the BOG as fuel for a local primer mover, or returning the BOG to a liquid state through the use of a re-liquefying system.

The presently disclosed system and method for managing boil-off gas in the fuel tank is directed at overcoming one or more of these disadvantages in currently available LNG fuel systems.

### SUMMARY

In accordance with an embodiment of the present disclosure, a liquid natural gas tank pressure management (LNG) system is provided. The system includes an LNG bulk tank, a LNG fuel tank operably connected to the LNG bulk tank, a compressed natural gas (CNG) accumulator operably connected to the LNG fuel tank, and an LNG cryogenic pump operably connected to the LNG fuel tank and the LNG bulk tank, wherein the pressure management system is configured to direct boil off gas to the compressed natural was accumulator upon a predetermined condition.

In accordance with an embodiment of the present disclosure, a method of assembling a liquid natural gas pressure management system is provided. The method includes providing an LNG bulk tank, connecting an fuel tank to the LNG bulk tank, connecting a CNG accumulator to the LNG fuel tank, connecting an LNG cryogenic pump to the LNG bulk tank and the LNG fuel tank; and configuring, the pressure management system to direct boil off gas to the CNG accumulator when a predetermined condition occurs.

In accordance with an embodiment of the present disclosure, a liquid natural gas tank pressure management system is provided. The system includes means for storing bulk LNG, means for storing LNG fuel operably connected to the means for storing bulk LNG, means for accumulating compressed natural gas (CNG) operably connected to the means for storing LNG fuel and means for pumping liquid natural gas operably connected to the means for storing bulk liquid natural gas and the means for storing liquid natural gas fuel. BOG is released from the LNG fuel tank and stored in the CNG accumulator upon a predetermined condition.

### BRIEF DESCRIPTION OF THE DRAWINGS

FIG. 1 presents a process diagram of a liquid natural gas tank vapor management system according to an embodiment of the present disclosure.

### DETAILED DESCRIPTION

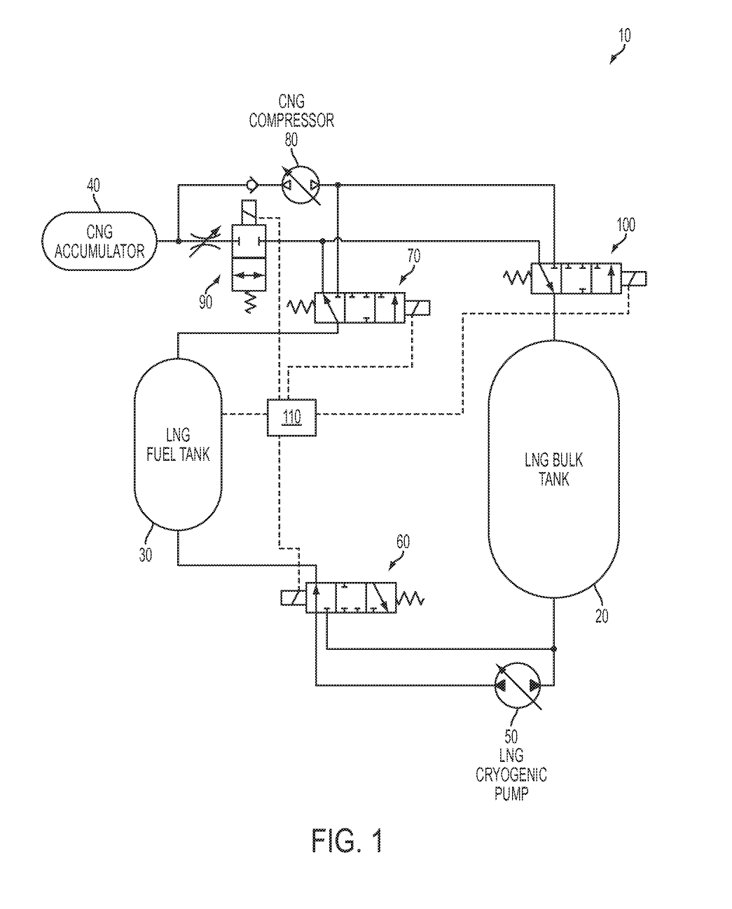

The present disclosure provides an LNG pressure management system 10 as shown in FIG. 1. The system 10 includes an LNG bulk tank 20, an LNG fuel tank 30 that may be operably connected to the LNG bulk tank 20 and a CNG accumulator 40 that is operably connected to the LNG fuel tank 30. BOG is released from the LNG fuel tank 30 and stored in the CNG accumulator 40 when certain conditions are met as described in detail below.

Natural gas is maintained in a liquid state in the LNG fuel tank 30. The LNG fuel tank 30 is an insulated cryogenic tank designed to hold liquefied natural gas at a very low temperature to maintain its liquefied form. For example, LNG is usually stored in the LNG fuel tank 30 at −260° F. and at 40 psig.

The LNG fuel tank 30 may be used to store LNG for a natural gas fuel system (not shown), e.g., to supply an engine that is powered by natural gas. The LNG fuel tank 30 defines a capacity to hold a certain volume of LNG and at a maximum operating pressure. The maximum operating pressure is the maximum pressure that the LNG fuel tank 30 can safely withstand without damage. The maximum operating pressure of the LNG fuel tank 30 may be a function of the capacity of the LNG fuel tank 30 as well as the operating conditions of the LNG fuel tank 30. The LNG fuel tank 30 may be configured to operate at pressures that are below the maximum operating pressure and may be operably connected to the LNG bulk tank 20 and operably connected to the CNG accumulator 40.

The LNG bulk tank 20 may be configured to store a large volume of LNG. The LNG bulk tank 20 may be an insulated cryogenic tank designed to hold. liquefied natural gas at a. very^{.} low temperature to maintain its liquefied form (i.e., −260° F. and at 40 psig). The LNG bulk tank 20 may be placed in ground, above ground or in LNG carriers. The LNG bulk tank 20 may be used to transfer LNG to and from the LNG fuel tank 30. Therefore, during refueling, the LNG bulk tank 20 supplies the LNG fuel tank 30 with LNG. During emptying, the LNG in the LNG fuel tank 30 is transferred to the LNG bulk tank 20.

The CNG accumulator 40 may be configured as a vessel to store BOG. The CNG accumulator 40 may be operated, at a higher pressure than the LNG fuel tank 30. The CNG accumulator 40 has the capacity to hold a certain volume of CNG at a maximum operating pressure. The maximum operating pressure is the maximum pressure that the CNG accumulator 40 can safely withstand without damage. The maximum operating pressure. of the CNG accumulator 40 may be a function of the capacity of the CNG accumulator 40 as well as the operating conditions of the LNG pressure management system 10. The CNG accumulator 40 may be configured to operate at pressures that are below the maximum operating pressure and may be operably connected to the LNG fuel tank 30. In some embodiments according to the present disclosure, the CNG accumulator 40 is operably connected to the LNG fuel tank 30 and the LNG bulk tank 20.

The LNG fuel tank 30 requires periodic refueling during normal operation. The LNG fuel tank 30 may also be discharged or emptied of LNG on occasion for service. The LNG hulk tank 20 contains LNG and is used to supply the LNG fuel tank 30 with LNG. An LNG cryogenic pump 50 may be used to pump the LNG from the LNG bulk tank 20 to the LNG fuel tank 30. An LNG transfer valve 60 may be operably connected between the LNG hulk tank 20 and the LNG fuel tank 30. During refueling, LNG flows from the LNG bulk tank 20 through the LNG cryogenic pump 50 through the LNG transfer valve 60 and into the LNG fuel tank 30.

The LNG fuel tank 30, however, inherently experiences some heat transfer caused by conduction to the LNG fuel tank 30 during filling and emptying procedures. The heat source may be from ambient temperature or it may be heat generated by various pieces of process equipment, such as the pumps and hoses used to transfer LNG from the LNG fuel tank 30 to the LNG bulk tank 20.

As heat is added to the LNG fuel tank 30, the temperature of the LNG rises and a portion of the LNG will evaporate, increasing pressure in the LNG fuel tank 30. The LNG fuel tank 30 may be configured to withstand some of these pressure increases from the evaporated liquid. However, when the pressure in the LNG fuel tank 30 becomes too high as a result of the evaporated LNG or vapor, the pressure may be reduced by releasing BOG.

A fuel vapor valve 70 may be operably connected between the LNG fuel tank 30 and the CNG accumulator 40. A CNG compressor 80 may also be used to transfer the BOG from the LNG fuel tank 30 to CNG accumulator 40. The CNG accumulator 40 and the GNU compressor 80 may also be part of the LNG refueling system (not shown).

When the pressure in the LNG fuel tank 30 exceeds the maximum operating pressure of the LNG fuel tank 30, the BOG from the LNG fuel tank 30 is released and stored in the CNG accumulator 40. BOG may be released from the LNG fuel tank 30 by flowing through the fuel vapor valve 70 and the CNG compressor 80 and pumped to the CNG accumulator 40.

In an embodiment according to the present disclosure, the fuel vapor valve 70 may be controlled using a controller 110. For example, pressure sensor(s) may be used. to measure the pressure within the LNG fuel tank 30. The controller 110 may be configured to receive a signal from the pressure sensor(s) and monitor the pressure of the LNG fuel tank 30. The controller 110 may be configured to operate the fuel vapor valve 70 to an open position to release BOG from the LNG fuel tank 30 when the pressure of the LNG fuel tank 30 exceeds the maximum operating pressure of the LNG fuel tank 30.

During, the refueling process, the LNG bulk tank 20 may be connected to the LNG fuel tank 30 through the LNG cryogenic pump 50 by way of the LNG transfer valve 60. BOG management may occur during refueling as the CNG accumulator 40 is connected to the vapor section of the LNG fuel tank 30 by way of the fuel vapor valve 70 and the CNG compressor 80 based on electrical commands received from the controller 110 during the refueling process. The CNG compressor 80 is employed to maximize the quantity of BOG stored in the CNG accumulator 40 and the LNG fuel tank 30. The controller 110 manages the LNG fuel tank 30 pressure as well as the CNG accumulator 40 pressure within predetermined pressure ranges for each throughout the refueling process.

When service procedures necessitate emptying the LNG fuel tank 30, LNG bulk tank 20 may be connected to the LNG fuel tank 30 by way of the LNG transfer valve 60 and the LNG cryogenic pump 50 is bypassed. BOG management may occur during the empting procedures as the CNG accumulator 40 is directly connected to the vapor section of the LNG fuel tank 30 by way of shut of valve 90 and fuel vapor valve 70. The CNG accumulator 40 pressure is applied to the vapor section of the LNG fuel tank 30 to push LNG from the liquid section of the LNG fuel tank 30 to the liquid section of the LNG bulk tank 20. The controller 110 manages LNG fuel tank 30 pressure within a predetermined pressure range throughout the emptying process.

During both the LNG refueling and emptying processes, the LNG valve 100 is used to isolate the CNG accumulator 40, shut off valve 90, CNG compressor 80 and the fuel vapor valve 70 from the LNG bulk tank 20. If emptying the LNG bulk tank 20 becomes necessary for service or maintenance reasons, the CNG accumulator 40 may be connected to the vapor section of the LNG bulk, tank 20 by way of the shut-off valve 90 and the LNG valve 100. In this case, the fuel vapor valve 70 would seal off the CNG portion of the LNG pressure management system 10 and the LNG transfer valve 60 would be used to transfer LNG front the LNG bulk tank 20 to another LNG storage system (not shown).

A similar process may be followed when the LNG bulk tank 20 is being filled. When filling the LNG bulk tank 20 the CNG accumulator 40 may be connected to the vapor section of the LNG bulk tank 20 by way of the CNG compressor 80 and the LNG valve 100. The LNG bulk tank 20 pressure is controlled based on electrical commands received by the LNG valve 100 from the controller 110 during refueling. The CNG compressor 80 is employed to maximize the amount of BOG stored in the CNG accumulator 40. In this case, the shut off valve 90 would prevent direct connection between the CNG accumulator 40 and the LNG bulk tank 20 and the fuel vapor valve 70 would seal off the CNG portion of the LNG pressure management system 10. The LNG transfer valve 60 would be used to transfer LNG from the LNG source (not shown) to the LNG bulk tank 20.

In an embodiment of the present disclosure, the CNG accumulator 40 may be removed from the pressure management system 10 and the BOG stored in the CNG accumulator 40 to be used in other natural gas applications. For example, the BOG may be re-liquefied and used in a natural gas powered engine. If design considerations permit, a re-liquefier may be included as part of the system 10. The CNG accumulator 40 may also be removed from the system 10 in certain circumstances and replaced with a new CNG accumulator 40.

During the refueling operation, the pressure within the CNG accumulator 40 may exceed the maximum operating pressure of the CNG accumulator 40. In this instance, it may no longer be feasible to continue to release BOG from the LNG fuel tank 30 and store the BOG in the CNG accumulator 40.

A shut-off valve 90 may be configured to close off the CNG accumulator 40 to prevent BOG flow to the CNG accumulator 40 and direct the BOG to the LNG bulk tank 20. Although there are disadvantages to introducing BOG to the LNG bulk tank 20, the ability to route BOG to the LNG bulk tank 20 provides an additional location on the LNG pressure management system 10 to transfer the BOG.

During emptying procedures, the LNG may be transferred from the LNG fuel tank 30 to the LNG bulk tank 20. The LNG flows from the LNG fuel tank 30 and through the LNG transfer valve 50 and into the LNG bulk tank 20. The presence of BOG in the LNG fuel tank 30 provides pressure to discharge the LNG from the LNG fuel tank 30 to the LNG bulk tank 20. Therefore, the more BOG in the LNG fuel tank 30, the greater the pressure in the LNG fuel tank 30 and the faster LNG will discharge from the LNG fuel tank 30.

BOG may also be present in the CNG accumulator 40 during emptying. Again, the presence of BOG will provide additional pressure to assist with the discharge of the LNG form the LNG fuel tank 30 to the LNG bulk tank 20. In this case, the shut-off valve 90 may be opened to release the BOG from the CNG accumulator 40 and allow the BOG to flow through the fuel vapor valve 70 and into the LNG fuel tank 30. LNG valve 100 may be closed, to prevent BOG from entering the LNG bulk tank 20. As the BOG flows into the LNG fuel tank 30, the pressure quickly discharges LNG from the LNG fuel tank 30. Once the LNG fuel tank 30 is emptied of LNG then the LNG fuel tank 30 and the natural gas fuel system (not shown) may be serviced.

### INDUSTRIAL APPLICABILITY

The LNG pressure management system 10 of the present disclosure may be applied to any engine that uses natural gas a fuel, including diesel/natural gas dual fuel powered engines. For example, machines that can be powered using natural gas, such as a truck, car, bus, or any mobile machine. The LNG pressure management system 10 of the present disclosure may also be used in off-highway machines such as mining trucks, locomotives and marine applications.

The LNG pressure management system 10 may be part of an LNG fuel station that is used to fill and empty an LNG fuel tank 30. The LNG pressure management system 10 of the present disclosure allows BOG that has accumulated in the LNG fuel tank 30 to be released from the LNG fuel tank 30 and stored in the CNG accumulator 40 when the LNG fuel tank 30 is being refueled. Using a CNG accumulator 40 to store the accumulated BOG from the LNG fuel tank 30 significantly reduces the time required to fill and empty the LNG fuel tank 30. The faster filling and emptying times allow the natural gas fuel system to return to operation faster and therefore greatly reduces downtime. Additionally, the LNG fuel tank 30 will also be able to hold a greater volume of LNG because the BOG that accumulates in the LNG fuel tank 30 during emptying and filling procedures is transferred to the CNG accumulator 40.

When the LNG fuel tank 30 is emptied, the BOG in the CNG accumulator 40 provides additional pressure that is used to discharge the LNG from the LNG fuel tank 30 and into the LNG bulk tank 20. This reduces the time required to discharge the LNG fuel tank 30 when the LNG fuel tank 30 needs to be serviced.

The many features and advantages of the disclosure are apparent from the detailed specification, and, thus, it is intended by the appended claims to cover all such features and advantages of the disclosure which fall within its true spirit and scope. Further, since numerous modifications and variations will readily occur to those skilled in the art, it is not desired to limit the disclosure to the exact construction and operation illustrated and described, and, accordingly, all suitable modifications and equivalents may be resorted to that fall within the scope of the disclosure.

We claim:

1. A liquid natural gas pressure management system, comprising:
a liquid natural gas bulk tank;
a liquid natural gas fuel tank operably connected to the liquid natural gas bulk tank; and
a compressed natural gas accumulator operably connected to the liquid natural gas fuel tank;
a liquid natural gas cryogenic pump operably connected to the liquid natural gas fuel tank and the liquid natural gas bulk tank;
wherein the pressure management system is configured to direct boil off gas to the compressed natural gas accumulator upon a predetermined condition.

2. The liquid natural gas pressure management system of claim 1, wherein the system is configured to release boil off gas from the liquid natural gas fuel tank and store the boil off gas in the compressed natural gas accumulator when liquid natural gas is transferred from the liquid natural gas bulk tank to the liquid natural gas fuel tank.

3. The liquid natural gas pressure management system of claim 1, wherein the system is configured to release boil off gas stored in the compressed natural gas accumulator to the liquid natural gas fuel tank to facilitate the transfer of liquid natural gas from the liquid natural gas fuel tank. to the liquid natural gas bulk tank without using the liquid natural gas cryogenic pump.

4. The liquid natural gas pressure management system of claim I wherein the compressed natural gas accumulator has a pressure that is greater than a pressure within. the liquid natural gas fuel tank.

5. The liquid natural gas pressure management system of claim 1, wherein boil off gas is released from the liquid natural gas fuel tank and stored in the compressed natural gas accumulator when the pressure of the liquid natural gas fuel tank exceeds the maximum operating pressure of the liquid natural gas fuel tank.

6. The liquid natural gas pressure management system of claim 1, wherein the boil off gas from the liquid natural gas fuel tank is released, to the liquid natural gas bulk tank when the pressure of the compressed natural gas accumulator exceeds the maximum operating pressure of the compressed natural gas accumulator and the pressure of the liquid natural gas fuel tank exceeds the maximum operating pressure of the liquid natural gas fuel tank.

7. The liquid natural gas pressure management system of claim 1, further comprising:
a controller configured to measure the pressure in the liquid natural gas fuel tank and
a fuel vapor valve operably connected to the liquid natural gas fuel tank and in communication with the controller,
wherein the controller is configured to operate the valve to release boil off gas from the liquid natural gas fuel tank to maintain the pressure of the liquid natural gas fuel tank within a predetermined pressure range.

8. The liquid natural gas pressure management system of claim 1, wherein the compressed natural gas accumulator is operably connected to the liquid natural gas bulk tank.

9. The liquid natural gas pressure management system of claim. 1, wherein the compressed natural gas accumulator is removed from the system and the boil off gas stored in the compressed natural gas accumulator is used in other natural gas applications.

10. The liquid natural gas pressure management system of claim 9, wherein boil off gas from the liquid natural gas bulk tank is released and stored in the compressed natural gas accumulator when the pressure in the liquid natural gas bulk tank exceeds the maximum operating pressure of the liquid natural gas bulk tank.

11. A method of assembling a liquid natural, gas pressure management system, comprising:
providing a liquid natural gas bulk tank;
connecting a liquid natural gas fuel, tank to the liquid natural gas bulk tank;
connecting a compressed natural gas accumulator to the liquid natural gas fuel tank;
connecting a liquid natural gas cryogenic, pump to the liquid natural gas bulk tank and the liquid natural gas fuel tank;
configuring the pressure management system to direct boil off gas to the compressed natural gas accumulator when a predetermined condition occurs.

12. The assembling method of claim 11, further comprising configuring the pressure management system to release boil off gas from the liquid natural gas fuel tank and store the boil off gas in the compressed natural gas accumulator when liquid natural gas is transferred from the liquid natural gas bulk tank to the liquid natural gas fuel tank.

13. The assembling method of claim 11, further comprising configuring the system to release boil off gas stored in the compressed natural gas accumulator to the boil off gas to the liquid natural gas fuel tank to facilitate the transfer of liquid natural gas from the liquid natural gas fuel tank to the liquid natural bulk tank without using the liquid natural gas cryogenic pump.

14. The assembling method of claim 11, wherein the compressed natural gas accumulator a pressure that is greater than a pressure within the liquid natural gas fuel tank.

15. The assembling method of claim 11, further comprising configuring the system to release boil off gas from the liquid natural gas fuel tank and stored in the compressed natural gas accumulator when the pressure of the liquid natural gas fuel tank exceeds the maximum operating pressure of the liquid natural gas fuel tank.

16. The assembling method of claim 11, further comprising configuring the system to release boil off gas from the liquid natural gas fuel tank to the liquid natural gas bulk tank when the pressure of the compressed natural gas accumulator exceeds the maximum operating pressure of the compressed natural gas accumulator and the pressure of the liquid natural gas fuel tank exceeds the maximum operating pressure of the liquid natural gas fuel tank.

17. The assembling method of claim 11, wherein the compressed natural gas accumulator is configured to be removed from the system and the boil off gas stored in the compressed natural gas accumulator is used in other natural gas applications.

18. The assembling method of claim 11, wherein the compressed natural gas accumulator is operably connected to the liquid natural gas bulk tank.

19. The assembling method of claim 18, wherein the system is configured to release boil off gas from the liquid natural gas bulk tank and store the boil off gas in the compressed natural gas accumulator when the pressure in the liquid natural gas bulk tank exceeds the maximum operating pressure of the liquid natural gas bulk tank.

20. A liquid natural gas tank pressure management system, comprising:
means for storing bulk liquid natural gas;
means for storing liquid natural gas fuel operably connected to the means for storing bulk liquid natural gas;
means for accumulating compressed natural gas operably connected to the means for storing bulk liquid natural gas;
means for pumping liquid natural gas operably connected to the means for storing bulk liquid natural gas and the means for storing liquid natural gas fuel, wherein boil off gas is released from the means for storing liquid natural gas fuel and stored in the means for accumulating compressed natural gas upon a predetermined condition.
